(19) United States
(12) Patent Application Publication
(10) Pub. No.: US 2026/0245131 A1
(43) Pub. Date: Aug. 20, 2026

(54) METHOD, APPARATUS, DEVICE, STORAGE MEDIUM AND PROGRAM PRODUCT FOR OBJECT PRESENTATION

(71) Applicant: Beijing Youzhuju Network Technology Co., Ltd., Beijing (CN)

(72) Inventors: Yizhi Wang, Beijing (CN); Tao Wang, Beijing (CN); Xiaojie Feng, Beijing (CN)

(21) Appl. No.: 19/160,808

(22) PCT Filed: Mar. 14, 2024
(86) PCT No.: PCT/CN2024/081786

§ 371 Date: Aug. 28, 2025

(30) Foreign Application Priority Data
Mar. 14, 2023 (CN) 202310250629.0

(51) Int. Cl. G06Q 30/0601

(52) U.S. Cl. CPC G06Q 30/0631; G06Q 30/0641

(57) ABSTRACT

The disclosure relates to a method, an apparatus, a device, a storage medium and a program product for object presentation, and the method includes: in response to receiving a trigger operation by a user, displaying a recommended resource presentation page, wherein the recommended resource presentation page includes a target candidate resource presentation area configured to present resource prompt information corresponding to a target object; in response to receiving a trigger operation for the target candidate resource presentation area, displaying an object presentation page corresponding to the target candidate resource presentation area, wherein the object presentation page is configured for the target object, resource attribute information corresponding to the target object, an associated object associated with the target object, and resource attribute information corresponding to respective associated objects.

This application claims the benefit of Chinese Patent Application No. 202310250629.0, entitled “METHOD, APPARATUS, DEVICE, STORAGE MEDIUM AND PROGRAM PRODUCT FOR OBJECT PRESENTATION,” filed Mar. 14, 2023, the entire content of which is incorporated herein by reference.

### FIELD

The present disclosure relates to the technical field of computer processing, in particular to a method, an apparatus, a device, a storage medium and a program product for object presentation.

### BACKGROUND

With the continuous progress and development of network technologies, a network shopping manner is accepted and liked by more and more users, and the user may be an individual or an enterprise.

With the increasing of the types and the number of the commodities that the user purchases on the internet, in order to improve the shopping efficiency of the user and the shopping experience of the user, the related technology can recommend the commodities to the user according to the requirement of each user so as to assist the user in selecting.

### SUMMARY

Embodiments of the present disclosure provide a method, an apparatus, a device, a storage medium and a program product for object presentation, and provides more object resource attribute information for a user to assist a user in selecting.

According to a first aspect, an embodiment of the present disclosure provides a method for object presentation, including: in response to receiving a trigger operation by a user, displaying a recommended resource presentation page, wherein the recommended resource presentation page comprises a target candidate resource presentation area configured to present resource prompt information corresponding to a target object; in response to receiving a trigger operation for the target candidate resource presentation area, displaying an object presentation page corresponding to the target candidate resource presentation area, wherein the object presentation page is configured for the target object, resource attribute information corresponding to the target object, an associated object associated with the target object, and resource attribute information corresponding to respective associated objects.

According to a second aspect, an embodiment of the present disclosure provides an apparatus for object presentation, including: a recommended resource presenting module, configured to in response to receiving a trigger operation by a user, display a recommended resource presentation page, wherein the recommended resource presentation page comprises a target candidate resource presentation area, and the target candidate resource presentation area is configured to present resource prompt information corresponding to the target object; an object presenting module, configured to in response to receiving a trigger operation for the target candidate resource presentation area, display an object presentation page corresponding to the target candidate resource presentation area, wherein the object presentation page is configured for a target object, resource attribute information corresponding to the target object, an associated object associated with the target object, and resource attribute information corresponding to respective associated objects.

According to a third aspect, an embodiment of the present disclosure provides an electronic device, including: one or more processors; a storage device, configured to store one or more programs; the one or more programs, when executed by the one or more processors, causing the one or more processors to implement the method according to any of the first aspect.

According to a fourth aspect, an embodiment of the present disclosure provides a computer-readable storage medium having stored thereon a computer program, wherein the program, when executed by a processor, implements the method according to any of the first aspect.

According to a fifth aspect, an embodiment of the present disclosure provides a computer program product, comprising a computer program or an instruction, wherein the computer program or instruction, when executed by a processor, implements the method according to any one of the first aspect is implemented.

### BRIEF DESCRIPTION OF DRAWINGS

Embodiments of the present disclosure will be described in more detail below with reference to the accompanying drawings. While certain embodiments of the present disclosure are shown in the drawings, it should be understood that the present disclosure may be embodied in various forms and should not be construed as limited to the embodiments set forth herein, but rather are provided for a more complete and thorough understanding of the present disclosure. It should be understood that the drawings and the embodiments of the present disclosure are for illustration purposes only and are not intended to limit the scope of the disclosure.

FIG. 1 illustrates an architectural diagram of an object presentation scenario according to an embodiment of the present disclosure;

FIG. 2 is a schematic flowchart of a method of object presentation according to an embodiment of the present disclosure;

FIG. 3 is a schematic diagram of a recommended resource presentation page according to an embodiment of the present disclosure;

FIG. 4 is a schematic diagram of an object presentation page according to an embodiment of the present disclosure;

FIG. 5 is a schematic diagram of an object presentation page according to an embodiment of the present disclosure;

FIG. 6 is a schematic diagram of a live streaming room picture according to an embodiment of the present disclosure;

FIG. 7 is a schematic structural diagram of an apparatus for object presentation according to an embodiment of the present disclosure;

FIG. 8 is a schematic structural diagram of an electronic device according to an embodiment of the present disclosure.

### DETAILED DESCRIPTION

Embodiments of the present disclosure will be described in more detail below with reference to the accompanying drawings. While certain embodiments of the present disclosure are shown in the drawings, it should be understood that the present disclosure may be embodied in various forms and should not be construed as limited to the embodiments set forth herein, but rather are provided for a more complete and thorough understanding of the present disclosure. It should be understood that the drawings and the embodiments of the present disclosure are for illustration purposes only and are not intended to limit the scope of the disclosure.

It should be understood that the steps recited in the method embodiments of the present disclosure may be performed in different orders, and/or in parallel. Further, the method embodiments may include additional steps and/or omit performing the illustrated steps. The scope of the present disclosure is not limited in this respect.

As used herein, the term “including/comprising” and variations thereof are open-ended, i.e., “including/comprising but not limited to”. The term “based on” is “based at least in part on”. The term “one embodiment” means “at least one embodiment”; the term “another embodiment” means “at least one further embodiment”; the term “some embodiments” means “at least some embodiments”. The relevant definitions of other terms will be given below.

It should be noted that the concepts such as “first” and “second” mentioned in present disclosure are merely used to distinguish different apparatuses, modules, or units, and are not intended to limit the order of functions performed by the apparatuses, modules, or units or the mutual dependency relationship.

It should be noted that the modification of “a” and “a plurality of” mentioned in present disclosure is illustrative and not limiting, and those skilled in the art should understand that they should be understood as “one or more” unless the context clearly indicates otherwise.

The names of messages or information exchanged between a plurality of apparatus in embodiments of the present disclosure are for illustrative purposes only and are not intended to limit the scope of such messages or information.

Before the embodiments of the present disclosure are described in further detail, the nouns and terms involved in the embodiments of the present disclosure are described, and the nouns and terms involved in the embodiments of the present disclosure are applicable to the following explanations.

“In response to” indicating a condition or state on which a performed operation depends, one or more operations performed when the dependent condition or state is satisfied may be in real time or may have a set delay; there is no restriction on the order of execution of the operations performed unless otherwise specified.

It can be understood that, before the technical solutions disclosed in the embodiments of the present disclosure are used, the types, usage scope, the usage scenario, and the like of personal information related to the present disclosure should be notified to the user in an appropriate manner according to the relevant laws and regulations and obtain the authorization of the user.

For example, in response to receiving an active request from a user, prompt information is sent to the user to explicitly prompt the user that the requested operation to be performed would require acquisition and use of personal information to the user. Thus, the user can autonomously select whether to provide personal information to software or hardware such as an electronic device, an application, a server, or a storage medium that performs the operations of the technical solution of the present disclosure, according to the prompt information.

As a possible but non-limiting implementation of the present disclosure, in response to receiving the active request from the user, the prompt information may be sent to the user in the form of a pop-up window, for example, and the prompt information may be presented in text in the pop-up window. In addition, the pop-up window may also carry a selection control for the user to select whether to “agree” or “disagree” to provide the personal information to the electronic device.

It may be understood that the foregoing notification and obtaining a user authorization process is merely illustrative and does not constitute a limitation on implementations of the present disclosure, and other manners of meeting related laws and regulations may also be applied to implementations of the present disclosure.

It may be understood that the data involved in the technical solution (including but not limited to the data itself, the acquisition or use of the data) should follow the requirements of the corresponding laws and regulations and related provisions.

With the increasing of the types and the number of the commodities that the user purchases on the internet, in order to improve the shopping efficiency of the user and the shopping experience of the user, the related technology can recommend the commodities to the user according to the requirement of each user so as to assist the user in selecting.

In the related art, in a process of selecting a commodity, a user usually needs to compare resource attribute information of a plurality of commodities and select a commodity satisfying a requirement of the user. The resource attribute information may include a plurality of conditions: a price of the commodity, a sales volume of the commodity, a delivery duration of the commodity, a browsing quantity of the commodity, and the like.

However, in the related art, a process in which the user compares resource attribute information of a plurality of commodities usually needs to open a detail page of a commodity, manually record resource attribute information corresponding to the commodity, close a detail page of the commodity, and then open a detail page of a next commodity. Such a loop reciprocates until a commodity satisfying its own needs is selected.

For example, when the resource attribute information is a commodity price, when the user compares prices of the plurality of same-style commodities, a detail page of the commodity A needs to be opened, a price of the commodity A is manually recorded, a detail page of the commodity A is closed, a detail page of the commodity B is opened, and a price of the commodity B is manually recorded. In this way, the recorded prices of the plurality of commodities are compared, and the commodity with the lowest price is selected.

For another example, when the resource attribute information is the commodity delivery duration, when the user compares the delivery duration of a plurality of same-style commodities, the user needs to open a detail page of the commodity A, manually record a delivery duration of the commodity A, close a detail page of the commodity A, open a detail page of the commodity B, and manually record a delivery duration of the commodity B. In this way, the recorded delivery durations of the plurality of commodities are compared, and the commodity with the shortest delivery duration is selected.

In the above selection process, the user needs to operate multiple times, resulting in operation redundancy, and the user can only select among the commodities selected by themselves, and cannot select among all the commodities in the whole platform, which is not conducive to the user to select a more suitable commodity.

Embodiments of the present disclosure provide a method, an apparatus, a device, a storage medium and a program product for object presentation. The method mainly comprises: in response to receiving a trigger operation by a user, displaying a recommended resource presentation page, wherein the recommended resource presentation page comprises a target candidate resource presentation area configured to present resource prompt information corresponding to a target object; in response to receiving a trigger operation for the target candidate resource presentation area, displaying an object presentation page corresponding to the target candidate resource presentation area, where the object presentation page is configured for the target object, resource attribute information corresponding to the target object, an associated object associated with the target object, and resource attribute information corresponding to respective associated objects.

According to embodiments of the present disclosure, the resource prompt information corresponding to the target object is presented the recommended resource presentation page, after the user triggers the resource prompt information corresponding to the target object, the resource attribute information of each type of object is presented, so that the operation of the user is reduced, the target object and the associated object of all the objects in the platform are selected for presentation, and more resource attribute information of the object is presented for the user to assist the user in selecting.

The method of object presentation provided in the embodiments of the present disclosure will be described in detail below with reference to the accompanying drawings.

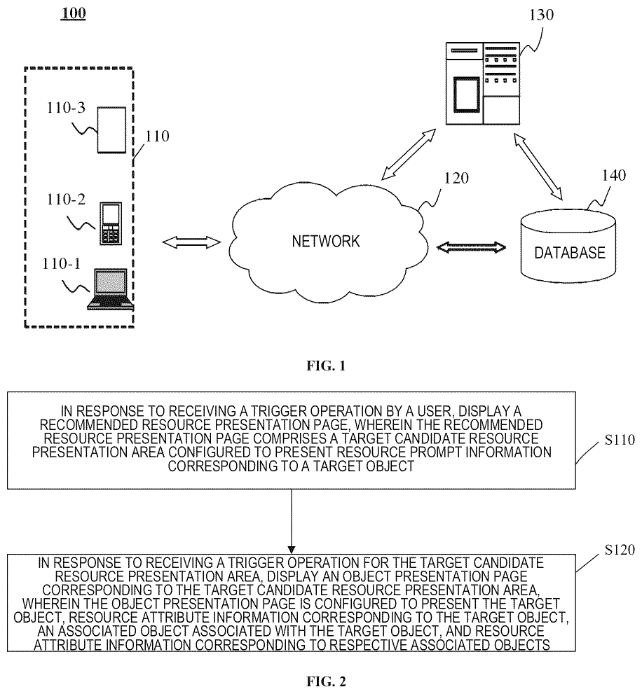

FIG. 1 is a system that may be used to implement the object presentation provided according to embodiments of the present disclosure. As shown in FIG. 1, a system 100 may include a plurality of user terminals 110, a network 120, a server 130, and a database 140. For example, the user terminal 110 may be configured to implement the method of object presentation according to any of the embodiments of the present disclosure.

It is understood that the user terminal 110 may be any other type of electronic device capable of performing data processing, which may include, but is not limited to, a mobile handset, a station, a unit, a device, a multimedia computer, a multimedia tablet, an Internet node, a communicator, a desktop computer, a laptop computer, a notebook computer, a netbook computer, a tablet computer, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination thereof, including accessories and peripherals of these devices, or any combination thereof.

The embodiments of the present disclosure are not limited to the hardware system and the software system of the user terminal 110, for example, the user terminal 110 may be an ARM, X86 based processor, and may have input/output devices such as a camera, a touch screen and a microphone, and may run an operating system such as Windows, iOS, Linux, Android, and a HarmonyOS.

The user terminal 110 may implement the method of object presentation provided in the embodiments of the present disclosure by running processes or threads. In some examples, the user terminal 110 may perform the method of object presentation using its built-in application. In some other examples, the user terminal 110 may perform the method of object presentation by invoking an application program stored outside the user terminal 110.

The network 120 may be a single network, or a combination of at least two different networks. For example, the network 120 may include, but is not limited to, one or a combination of several of a local area network, a wide area network, a public network, a private network, and the like. The network 120 may be a computer network such as the Internet and/or various telecommunication networks (e.g., 3G/4G/5G mobile communication networks, WIFI, Bluetooth, ZigBee, etc.), which is not limited in the embodiments of the present disclosure.

The server 130 may be a separate server, a server group, or a cloud server, and each server in the server group is connected through a wired or wireless network. One server group may be centralized, for example, a data center, or may be distributed. The server 130 may be local or remote. The server 130 may communicate with the user terminal 110 through a wired or wireless network. The embodiments of the present disclosure are not limited to the hardware system and the software system of the server 130.

The database 140 may generally refer to a device having a storage function. The database 140 is mainly configured to store various data utilized, generated and output by the user terminal 110 and the server 130 in operation. The database 140 may be local or remote. The database 140 may include various memories, for example, a random-access memory (RAM), a read-only memory (ROM), or the like. The storage devices mentioned above are merely examples, and storage devices that can be used by the system 100 are not limited thereto. Embodiments of the present disclosure are not limited to the hardware system and software system of the database 140, for example, may be a relational database or a non-relational database.

The database 140 may be connected to or in communication with the server 130 or a part thereof via the network 120, or directly connected to or in communication with the server 130, or a combination thereof.

In some examples, the database 140 may be a standalone device. In other examples, the database 140 may also be integrated in at least one of the user terminal 110 and the server 130. For example, the database 140 may be disposed on the user terminal 110 or on the server 130. For another example, the database 140 may also be distributed, a part of which is disposed on the user terminal 110, and another part is disposed on the server 130.

FIG. 2 is a flowchart of a method of object presentation according to an embodiment of the present disclosure. The present embodiment is applicable to a case of presenting resource attribute information of an object, and the method may be executed by an apparatus for object presentation, where the apparatus for object presentation may be implemented in a software and/or hardware manner, and the apparatus for object presentation may be configured in an electronic device as shown in FIG. 1.

As shown in FIG. 2, the method of object presentation provided by the embodiment of the present disclosure mainly includes steps S101-S102.

S101: in response to receiving a trigger operation by a user, display a recommended resource presentation page, where the recommended resource presentation page includes a target candidate resource presentation area configured to present resource prompt information corresponding to a target object.

In an embodiment of the present disclosure, the recommended resource presentation page may be understood as a page used to present the recommended resource in the client. The recommended resource presentation page can be understood as referring to a page for presenting recommended resources in the client. The clients may include various clients including recommended resource pages used in daily life, such as an instant messaging client, a video client, a live streaming client, a shopping client, an information client, a game client, a sports health client, a tool client, a trip client, a shooting client, a reading client, and the like. In the embodiment of the present disclosure, the client is a short video client as an example. In one possible implementation of the present disclosure, the recommended resource presentation page may be a live steaming room recommendation page, a short video recommendation page, a commodity recommendation page, or the like.

In some embodiments, the recommended resource may include at least one or a combination of a text, an image, and a video. For example, the recommended resource presentation page may be a video recommendation page in a short video client. For another example, the recommended resource presentation page may be a live streaming room recommendation page in the short video client.

In an implementation of the present disclosure, displaying the recommended resource presentation page in response to receiving the trigger operation by the user includes: displaying the recommended resource presentation page in response to receiving an opening operation of the user on the client on the terminal device.

In an embodiment of the present disclosure, displaying the recommended resource presentation page in response to receiving the trigger operation by the user includes: when a user browses other pages by using the client, the information flow page is displayed in response to receiving a trigger operation on a setting control in the client and receiving an information flow page presentation instruction. In some embodiments, the setting control is presented in the client for presenting the information flow page after being triggered.

In an embodiment of the present disclosure, the recommended resource presentation page includes a plurality of candidate resource presentation areas. In some embodiments, the plurality of candidate resource presentation areas includes a target candidate resource presentation area, and there may be one or more target candidate resource presentation areas in the recommended resource presentation page, which are not specifically limited in the embodiments of the present disclosure.

Further, the target candidate resource presentation area is configured to present resource prompt information corresponding to the target object. Other candidate resource presentation areas other than the target candidate resource presentation area are configured to present other recommended resources. In a possible implementation of the present disclosure, the other recommended resources may include one or more of: a recommended video stream, a recommended live streaming room, a recommended commodity, a recommended work, and the like.

In an embodiment of the present disclosure, a position of the target resource presentation area in the recommended resource presentation page may be predetermined. For example, the target resource presentation area is displayed at the fourth position in the recommended resource presentation page.

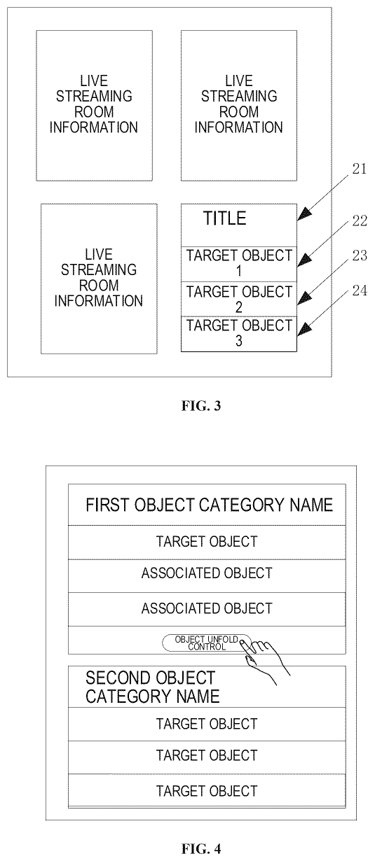

In an embodiment of the present disclosure, as shown in FIG. 3, an example in which the recommended resource presentation page includes 4 candidate resource presentation areas is used for description. As shown in FIG. 3, the candidate resource presentation area may be presented in a form of a card. The recommended resource presentation page is configured to present resource prompt information corresponding to the target object, and the other candidate resource presentation areas are configured to present related information of the recommended live streaming room.

In an embodiment of the present disclosure, the resource prompt information may be understood as resource attribute information corresponding to a prompt target object for comparison. For example, the resource prompt information may include a comparison of resource attribute information, such as: price comparison, delivery duration comparison, sales volume comparison, view volume comparison, and the like. The resource attribute information may be understood as information indicating object attributes specific to the target object or the associated object. The resource attribute information may include fixed resource attribute information and dynamic resource attribute information. For example, the fixed resource attribute information may be a brand to which the object belongs, an object model, and the like. The dynamic resource attribute information may be an object picture, an object title, an object price, an object view volume, an object delivery duration, an object sales volume, and the like.

In an implementation of the present disclosure, the resource prompt information corresponding to the target object may further include target object associated information and resource attribute information corresponding to the target object. In some embodiments, the resource attribute information includes a price, a delivery duration, a sales volume, a view volume, and the like. The target object associated information includes a target object title and a target object image.

In an embodiment of the present disclosure, the target object is an object determined based on a predetermined object. In some embodiments, the predetermined object includes one or more of: a browsed object recommended in a live streaming room, a browsed object recommended in a video information flow, an object corresponding to browsed object attribute detail information, or an object for which a predetermined interactive operation has been performed.

In an implementation of the present disclosure, the target object is an object determined based on a predetermined object and may include: a predetermined object is taken as a target object, or the object satisfying the predetermined condition in the object category to which the predetermined object belongs is taken as the target object.

In an implementation of the present disclosure, using the predetermined object as the target object may include one or more of: using a browsed object recommended in a live streaming room as a target object, using a browsed object recommended in a video information flow as a target object, taking an object corresponding to browsed object attribute detail information as a recommendation object, and taking an object for which a predetermined interactive operation has been performed as a target object.

In an embodiment of the present disclosure, the browsed object recommended in the live streaming room may include: a recommended object with the highest sales volume in the live streaming room, a recommended object with the lowest price in the live streaming room, a recommended object with the latest browsing time in the live streaming room, a recommended object with the highest view volume in the live streaming room, and a recommended object that has browsed but not placed in the live streaming room. For example, the user browses the latest recommended object B in the live streaming room A (in other words, the last recommended object B browsed by the user in the live streaming room A) and uses the recommended object B as the target object.

In the embodiments of the present disclosure, the browsed object recommended in the video information flow may include: a recommended object mounted in the browsed video information stream, or a recommended object in the browsed video content. For example, after browsing the video information stream, the user uses the object mounted in the video that has the latest browsing time as the target object. For another example, after browsing the video information stream, the user uses the recommended object in the video content in the latest video of the browsing time as the target object.

In the embodiments of the present disclosure, the object corresponding to the browsed object attribute detail information may be understood as an object that has browsed the corresponding attribute detail information. In some embodiments, the attribute detail information may include: an object title, an object picture, object resource attribute information, an object function introduction, an object use description, and the like.

In an embodiment of the present disclosure, the predetermined interaction operation has been performed and may include one or more of: an operation of adding a shopping cart to the object, an attention operation on the object, an ordering operation on the object, and the like.

In an implementation of the present disclosure, taking an object satisfying predetermined conditions in an object category to which a predetermined object belongs as a target object, the method includes: obtaining an object category to which a predetermined object belongs, and taking an object satisfying predetermined conditions in the object category as a target object.

In an implementation of the present disclosure, if the target object is one of at least one object and the at least one target object is of a same object category, a plurality of target objects of the same object category is presented in the target candidate resource presentation area and the resource attribute information of the plurality of target objects satisfies a first predetermined condition. In some embodiments, the first predetermined condition includes that after respective resource attribute information of the target object and the associated object of the object category are sorted based on a set rule, a first predetermined number of resource attribute information sorted in the front.

In an embodiment of the present disclosure, if the number of target objects is 1, that is, only resource prompt information of one target object is present in the target candidate resource presentation area, and the target object is an object whose resource attribute information satisfies a second predetermined condition in the object category. In some embodiments, the second predetermined condition includes a minimum resource attribute information and a maximum resource attribute information.

In an example embodiment, the predetermined object is a mobile phone of the brand A model B recommended by the X live streaming room, the brand A type B is clustered as the object category, the resource attribute information of all the mobile phones of the brand A model B is obtained, and the object corresponding to the minimum resource attribute information or the maximum resource attribute information is used as the target object. For example, taking the resource attribute information as a price as an example, the mobile phone with the smallest price in all the mobile phones with the brand A model B is used as the target object. For another example, taking the resource attribute information as the sales volume as an example, the mobile phone with the largest sales volume in all the mobile phones with the brand A model B is used as the target object.

In the embodiments of the present disclosure, the target object is one of a plurality of target objects, which may be understood as presenting resource prompt information of a plurality of target objects in the target candidate resource presentation area, as shown in FIG. 3, an example in which the target object is 3 is taken as an example for description in the embodiments of the present disclosure.

In an embodiment of the present disclosure, the object category is a minimum unit of commodity information aggregation, for example, a mobile phone brand+model may be used as an object category. Further, the plurality of target objects are objects of a same category, and a plurality of target objects in the same object category are presented in the target candidate resource presentation area.

In an embodiment of the present disclosure, after the predetermined object is determined, an object category to which the predetermined object belongs is obtained, resource attribute information of all objects in the object category is sorted based on a set rule, and taking a first predetermined number of resource attribute information sorted in the front as target objects.

In an example embodiment, the predetermined object is a mobile phone of the brand A model B recommended by the X live streaming room, the brand A model B is clustered as the object category, the resource attribute information of all the mobile phones of the brand A model B number is obtained, the resource attribute information of all the mobile phones is sorted based on a set rule, and the first predetermined number of resource attribute information sorted in the front is used as the target object. Specifically, when the resource attribute information is the price and the delivery duration, the setting rule may be sorted in ascending order, and when the resource attribute information is the sales volume and the browsing volume, the setting rule may be sorted in descending order.

For example, the prices of all the mobile phones of the brand A model B are sorted in ascending order, and the mobile phone sorted in front 3 is used as the target object. For another example, the sales volume of all the mobile phones with brand A model B is sorted in descending order, and the mobile phone sorted in front 3 is used as the target object.

In an implementation of the present disclosure, if the plurality of target objects is of a same object category, labeling a target object with smallest resource attribute information with a set identifier, wherein the set identifier is configured to indicate that the target object is the object with smallest resource attribute information. Or if the plurality of targets belong to the same object category, labeling the target object with largest resource attribute information with a set identifier.

In an implementation of the present disclosure, if the target object is one of a plurality of target objects and the plurality of target objects is of a plurality of object categories, only one target object in each object category is presented in the target candidate resource presentation area. In some embodiment, resource attribute information of the target object presented in the each object category satisfies a second predetermined condition, and the second predetermined condition includes that for each object category, the presented target object corresponding to the object category is an object with smallest resource attribute information in the object category, or the presented target object corresponding to the object category is an object with largest resource attribute information in the object category; the presenting order of the target objects corresponding to the plurality of object categories respectively is determined based on historical browsing times corresponding to respective object categories respectively.

In the embodiment of the present disclosure, the plurality of target objects may be of a plurality of object categories, further, the number of the target objects may be greater than the number of the object categories, and the number of the target objects may also be equal to the number of the object categories. In a possible implementation of the present disclosure, a number of target objects is equal to a number of object categories, that is, each object category only presents one target object.

In an embodiment of the present disclosure, after the plurality of predetermined objects are determined, an object category to which each predetermined object belongs is obtained, for each object category, an object with smallest resource attribute information in the object category is used as a target object, or for each object category, an object with largest resource attribute information in the object category is used as a target object.

In an example embodiment, an example in which the resource attribute information is a price is used as an example for description, the predetermined object is a mobile phone of the brand A model B recommended in the X live streaming room, the mobile phone of the brand A model B is clustered as the object category, the price of all the mobile phones of the brand A model B is obtained, and the mobile phone with the lowest price is used as the target object. The predetermined object is a brand AA style BB short sleeve recommended by the XX live streaming room, the short sleeve of the brand AA style BB is clustered as the object category, the price of all the short sleeves of the brand AA style BB is obtained, and the short sleeve with the lowest price is used as the target object. The predetermined object is the lipstick of the brand AAA type BBB recommended by the XXX live streaming room, the lipstick of the brand AAA type BBB is clustered as the object category, the price of all the lipsticks of the brand AAA type BBB is obtained, and the lipstick with the lowest price is used as the target object.

In the embodiment of the present disclosure, the presenting order of the target objects respectively corresponding to the plurality of object categories is consistent with the reverse order of the historical browsing time respectively corresponding to each object category. For example, the historical browsing time of the object category to which the target object A belongs is XX hour 10 minutes and 05 seconds in XX day, the historical browsing time of the object category to which the target object B belongs is XX hour 5 minutes and 25 seconds in XX day, the historical browsing time of the object category to which the target object C belongs is XX hour 26 minutes and 17 seconds in XX day, the reverse order of the historical browsing sequence is XX hour 26 minutes and 17 seconds in XX day, XX hour 10 minutes and 05 seconds in XX day, and XX hour 5 minutes and 25 seconds in XX day. Accordingly, the presenting sequence of the target object is target object C, target object a and target object B.

S102, in response to receiving a trigger operation for the target candidate resource presentation area, display an object presentation page corresponding to the target candidate resource presentation area, where the object presentation page is configured for the target object, resource attribute information corresponding to the target object, an associated object associated with the target object, and resource attribute information corresponding to respective associated objects.

In the embodiments of the present disclosure, the trigger operation for the target candidate resource presentation area may be a trigger operation for any position in the target candidate resource presentation area. For example, the trigger operation may be a trigger operation on the blank area of the target candidate resource presentation area or may be a trigger operation on the resource prompt information in the target candidate resource presentation area. The embodiments of the present disclosure are not specifically limited in the embodiments of the present disclosure.

In the embodiments of the present disclosure, the associated object related to the target object may be understood as an object belonging to a same object category as the target object.

In an embodiment of the present disclosure, when there are a plurality of target objects and the plurality of target objects belong to a same object category, the associated objects related to the target object may be understood as objects belonging to a same object category as the target object; in other words, the associated object and the plurality of target objects related to the target object belong to a same category.

In one embodiment of the present disclosure, when there are a plurality of target objects and a plurality of target objects belong to a plurality of object categories, for each target object, there is an associated object associated with the target object, and an associated object associated with the target object and the target object belong to a same category. For example, the object category AA to which the target object A belongs is an associated object included in the object category AA. The object category BB to which the target object B belongs is an associated object included in the object category BB.

In a possible implementation of the present disclosure, the target object and the target object b belong to the object category A, and the associated object related to the target object a and the target object b is an associated object included in the object category A. The associated object related to the target object c is an associated object included in the object category B.

In an embodiment of the present disclosure, as shown in FIG. 4, a plurality of object presentation areas are included in an object presentation page, each object presentation area is configured to present a plurality of objects belonging to a same category and resource attribute information corresponding to each object, and the object may include a target object and an associated object associated with the target object.

As shown in FIG. 4, an object category name is presented in each object presentation area, where the object category name is a short title of which a target object and an associated object included in the object category are repeated a plurality of times. If the target object and the associated object included in the object category have no repeated short titles, the short title corresponding to the target object is taken.

In one embodiment of the present disclosure, as shown in FIG. 3, the target candidate resource presentation area includes a first area 21 and at least one or more second areas, each of the second areas respectively present resource attribute information corresponding to one target object, and the target object presented in each second area is different; the first area is an area other than the second area in the target candidate resource presentation area. For example, the second area 22 is configured to present resource attribute information corresponding to the target object 1, the second area 23 is configured to present resource attribute information corresponding to the target object 2, and the second area 24 is configured to present resource attribute information corresponding to the target object 3. The first area is an area other than the second area in the target candidate resource display area.

In an embodiment of the present disclosure, when there are a plurality of target objects and a plurality of target objects belong to a plurality of object categories, displaying, in response to receiving a trigger operation for the target candidate resource presentation area, an object presentation page corresponding to the target candidate resource presentation area includes: in response to receiving a trigger operation for any of the second areas, displaying, in the object presentation page, resource attribute information corresponding to a target object corresponding to a triggered second area and resource attribute information corresponding to an associated object related to the target object.

In the embodiment of the present disclosure, the user may trigger any second area according to his/her preference, and in response to receiving a trigger operation for the second area, obtain a target object corresponding to the triggered second area, and present, in the object presentation page, resource attribute information corresponding to the target object corresponding to the triggered second area and resource attribute information corresponding to the associated object related to the target object.

In an example implementation, in response to receiving a trigger operation for the second area 23, the resource attribute information corresponding to the target object 2 and the resource attribute information corresponding to the associated object related to the target object 2 are obtained, and the resource attribute information corresponding to the target object 2 and the resource attribute information corresponding to the associated object related to the target object 2 are presented in the object presentation page.

In the embodiment of the present disclosure, presenting the resource attribute information corresponding to the target object corresponding to the triggered second area and the resource attribute information corresponding to the associated object in the object presentation page includes: presenting the resource attribute information corresponding to the target object corresponding to the triggered second area and the resource attribute information corresponding to the associated object in the first object presentation area in the object presentation page. The other object presentation areas are configured to present resource attribute information corresponding to other target objects, and resource attribute information corresponding to the associated objects related to the other target objects.

In an implementation of the present disclosure, when there are a plurality of target objects and a plurality of target objects belong to a plurality of object categories, displaying, in response to receiving a trigger operation for the target candidate resource presentation area, an object presentation page corresponding to the target candidate resource presentation area includes: in response to receiving a trigger operation for the first area, displaying, in the object presentation page, resource attribute information corresponding to a target object included in all object categories, and resource attribute information corresponding to an associated object included in all object categories related to the target object.

In the embodiments of the present disclosure, there are a plurality of target objects, and when the plurality of target objects belong to the plurality of object categories, the user triggers any position in the first area, the display object presentation page, object presentation page includes a plurality of object display areas, and each object presentation area is configured to display the resource attribute information corresponding to the target object included in the category of object categories and the resource attribute information corresponding to the associated object.

In an embodiment of the present disclosure, presenting order of the target object or the associated object comprised in each object category presented in the object presentation page is determined by a sorting order of the resource attribute information corresponding to the target object or the associated object; and in accordance with a determination that the resource attribute information of at least two objects is the same, the presenting order of the at least two objects is determined by the association relationship between the user and a user associated with the object, and the at least two objects include the target object and/or the associated object.

In an embodiment of the present disclosure, the presenting order of the target object and the associated object included in the object category is consistent with the order of the corresponding resource attribute information. The corresponding resource attribute information includes resource attribute information corresponding to the target object, and resource attribute information corresponding to the associated object. Specifically, presenting order of the target object and the associated object is an ascending order of the resource attribute information, or the presenting order of the target object and the associated object is a descending order of the resource attribute information. Further, the resource attribute information sorting is to sort the resource attribute information corresponding to the target object included in the same object category and the resource attribute information of the associated object related to the target object in the same object category.

Further, when the resource attribute information of the at least two objects is consistent, it may be determined based on a relationship between the user and the user associated with object. The user associated with object may be understood as a publisher of the object. For example, a live streaming room anchor mounting the object, a user publishing a video for mounting the object, a store to which the user belongs is selling the object, and the like.

In the embodiments of the present disclosure, the determining based on the relationship between the user and the user associated with object may be based on an intimacy determination between the user and the user associated with object. For example, the user focuses on the associated user, and the corresponding object is preferentially displayed. Historically associated associative users, their corresponding objects are preferentially displayed.

In an embodiment of the present disclosure, the object presentation area includes an object unfold control, and the method further includes: presenting resource attribute information corresponding to a first predetermined number of target objects and resource attribute information corresponding to an associated object in the object presentation area; and in response to a trigger operation for the unfold control, acquiring resource attribute information corresponding to a second predetermined number of target objects and resource attribute information corresponding to an associated object, and presenting the resource attribute information in the object presentation area, where the first predetermined number is less than a second predetermined number.

In an embodiment of the present disclosure, as shown in FIG. 4, the first predetermined number is 3 as an example for description, and resource attribute information corresponding to 3 objects included in the object category is presented in one object presentation area. If the number of objects included in the object category exceeds the first predetermined number (for example, 3), the object unfold control is presented in the object presentation area, and in response to receiving the trigger operation for the object unfold control, the resource attribute information corresponding to all the objects in the object category is presented in the object presentation area, as shown in FIG. 5. In some embodiments, the object included in the object category includes: a target object and an associated object within the object category.

Further, if the number of second objects included in the object category is more, and cannot be completely presented in the current page, the plurality of second objects is displayed in a sliding manner in response to the upward sliding operation of the user.

In one embodiment of the present disclosure, in response to a trigger operation for any target object or associated object in the object presentation page, displaying a page associated with object. In some embodiments, the page associated with the object comprises a combination of one or more of: an object detail page, configured to present attribute detail information of a triggered target object or an associated object, the attribute detail information comprises at least one or more of: an object title, resource attribute information of an object, and an object picture; a target live streaming room page, wherein the target live streaming room page is a presentation page of a live streaming room associated with the triggered target object or the associated object; a target multimedia page, wherein the target multimedia is a multimedia content presentation page associated with the triggered target object or the associated object.

In an embodiment of the present disclosure, in response to a trigger operation for any target object or associated object in the object presentation page, a detail page of the triggered target object or associated object is displayed, the object detail page is configured to present attribute detail information of the triggered target object or associated object, and the attribute detail information includes at least one or more of: an object title, resource attribute information of the object, an object picture, and the like.

In one embodiment of the present disclosure, in response to a trigger operation for any object in the object presentation page, the target live streaming room page is a presentation page of a live streaming room associated with the triggered target object or the associated object.

The live streaming room associated with the triggered object refers to that the mount is triggered to correspond to the live streaming room.

In the embodiment of the present disclosure, the target live streaming room page is configured to display a picture in which the target live streaming room is live. Further, an object panel may be presented in the target live streaming room page, and the object panel is configured to present attribute detail information of the triggered object.

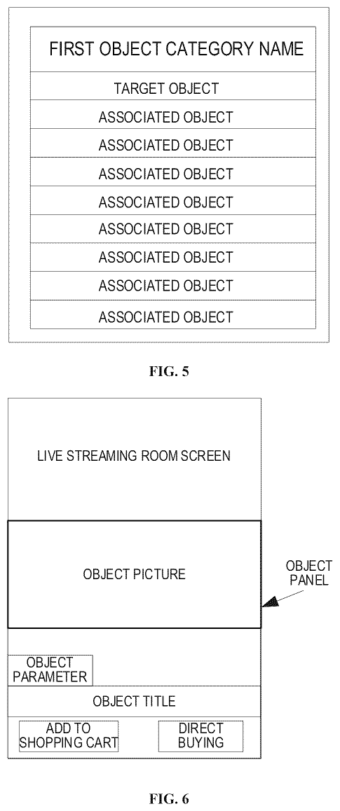

In an embodiment of the present disclosure, as shown in FIG. 4 and FIG. 5, in response to a trigger operation for a target object or an associated object, a target live streaming room associated with the triggered target object or associated object is obtained. As shown in FIG. 6, a live streaming picture corresponding to a target live streaming room is presented, and an object panel is pulled in the live streaming picture to present attribute detail information of a triggered target object or an associated object. For example, the attribute detail information of the object includes a picture of the object, resource attribute information, an object title, and an add shopping cart control and an immediate purchase control, the add shopping cart control is configured to add the second object to the shopping cart in response to a trigger operation of the user, and the immediate purchase control is configured to jump to the payment page corresponding to the second object in response to a trigger operation of the user.

In one embodiment of the present disclosure, in response to a trigger operation for any target object or associated object in the object presentation page, a target multimedia page is presented, where the target multimedia is a multimedia content presentation page associated with the triggered target object or associated object.

In an embodiment of the present disclosure, the multimedia content associated with the triggered target object or associated object may be the multimedia content corresponding to the mount of the triggered target object or associated object, and the multimedia content may be a video stream.

In an embodiment of the present disclosure, the target multimedia page is configured to display the target multimedia content. Further, an object panel may be presented in the target multimedia page, and the object panel is configured to present attribute detail information of the triggered target object or the associated object.

Embodiments of the present disclosure provide a method, an apparatus, a device, a storage medium and a program product for object presentation, the method include: in response to receiving a trigger operation by a user, displaying a recommended resource presentation page, wherein the recommended resource presentation page comprises a target candidate resource presentation area configured to present resource prompt information corresponding to a target object; in response to receiving a trigger operation for the target candidate resource presentation area, displaying an object presentation page corresponding to the target candidate resource presentation area, where the object presentation page is configured for the target object, resource attribute information corresponding to the target object, an associated object associated with the target object, and resource attribute information corresponding to respective associated objects. According to the embodiment of the present disclosure, the resource prompt information corresponding to the target object is presented in the recommended resource presentation page, after the user triggers the resource prompt information corresponding to the target object, the resource attribute information of each type of object is presented, and more resource attribute information of the object is displayed for the user, so that the user is assisted to select.

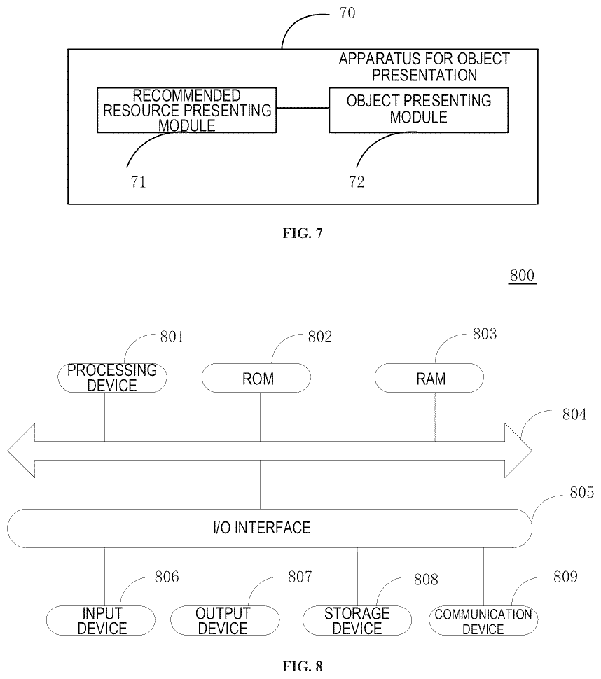

FIG. 7 is a schematic structural diagram of an apparatus for object presentation according to an embodiment of the present disclosure. The present embodiment is applicable to the case of centralized presentation of objects of the same category, and the apparatus for object presentation may be implemented in software and/or hardware, and may be configured in an electronic device.

As shown in FIG. 7, the apparatus for object presentation 70 provided by an embodiment of the present disclosure mainly includes a recommended resource presenting module 71 and an object presenting module 72.

The recommended resource presenting module 71, configured to in response to receiving a trigger operation by a user, display a recommended resource presentation page, where the recommended resource presentation page includes a target candidate resource presentation area, and the target candidate resource presentation area is configured to present resource prompt information corresponding to the target object; and an object presenting module 72, configured to in response to receiving a trigger operation for the target candidate resource presentation area, display an object presentation page corresponding to the target candidate resource presentation area, where the object presentation page is configured for a target object, resource attribute information corresponding to the target object, an associated object associated with the target object, and resource attribute information corresponding to respective associated objects.

In an embodiment of the present disclosure, the target object is an object determined based on a predetermined object comprising one or more of: a browsed object recommended in a live streaming room, a browsed object recommended in a video information flow, an object corresponding to browsed object attribute detail information, or an object for which a predetermined interactive operation has been performed.

In an implementation of the present disclosure, if the target object is one of at least one object and the at least one target object is of a same object category, a plurality of target objects of the same object category is presented in the target candidate resource presentation area and the resource attribute information of the plurality of target objects satisfies a first predetermined condition, where the first predetermined condition comprises that after respective resource attribute information of the target object and the associated object of the object category are sorted based on a set rule, a first predetermined number of resource attribute information sorted in the front.

In an implementation of the present disclosure, if the target object is one of a plurality of target objects and the plurality of target objects is of a plurality of object categories, only one target object in each object category is presented in the target candidate resource presentation area, where the resource attribute information of the target object presented in the each object category satisfies a second predetermined condition, and the second predetermined condition comprises that for each object category, the presented target object corresponding to the object category is an object with smallest resource attribute information in the object category, or the presented target object corresponding to the object category is an object with largest resource attribute information in the object category; the presenting order of the target objects corresponding to the plurality of object categories respectively is determined based on historical browsing times corresponding to respective object categories respectively.

In one embodiment of the present disclosure, the target candidate resource presentation area includes a first area and at least one second area, each second area presents resource attribute information corresponding to one target object, and the target object presented in each second area is different; and the first area is an area other than the second area in the target candidate resource presentation area; the object presenting module 72 is specifically configured to, in response to receiving a trigger operation for any second area, displaying, in the object presentation page, resource attribute information corresponding to a target object corresponding to the triggered second area and resource attribute information corresponding to an associated object related to the target object; and in response to receiving a trigger operation for the first area, displaying, in the object presentation page, resource attribute information corresponding to a target object comprised in all object categories, and resource attribute information corresponding to an associated object comprised in all object categories related to the target object.

In one embodiment of the present disclosure, the display order of the target object or the associated object included in each object category displayed in the object presentation page is determined by the sorting sequence of the resource attribute information corresponding to the target object or the associated object; and if the resource attribute information of the at least two objects is the same, the display order of the at least two objects is determined by the association relationship between the user and the object associated user, and the at least two objects include the target object and/or the associated object.

In an implementation of the present disclosure, the apparatus further includes: an object association page presenting module, configured to in response to a trigger operation for any target object or associated object in the object presentation page, displaying a page associated with object, where the page associated with the object includes a combination of one or more of: an object detail page, configured to present attribute detail information of a triggered target object or an associated object, wherein the attribute detail information comprises at least one or more of: an object title, resource attribute information of an object, and an object picture; a target live streaming room page, wherein the target live streaming room page is a presentation page of a live streaming room associated with the triggered target object or the associated object; a target multimedia page, where the target multimedia is a multimedia content presentation page associated with the triggered target object or the associated object.

The apparatus for adjusting an object presentation provided by the embodiments of the present disclosure may perform the steps performed in the method of object presentation provided by the embodiments of the present disclosure, and has the following steps and beneficial effects, which are not described herein again.

FIG. 8 is a schematic structural diagram of an electronic device according to an embodiment of the present disclosure. Referring below specifically to FIG. 8, and FIG. 8 shows a schematic structural diagram of an electronic device 800 suitable for implementing the embodiments of the present disclosure. The electronic device 800 in the embodiments of the present disclosure may include, but is not limited to, a mobile terminal such as a mobile phone, a notebook computer, a digital broadcast receiver, a PDA (personal digital assistant), a PAD (tablet computer), a PMP (portable multimedia player), an in-vehicle terminal (for example, an in-vehicle navigation terminal), a wearable terminal device, and the like, and a fixed terminal such as a digital TV, a desktop computer, a smart home device, or the like. The electronic device shown in FIG. 8 is merely an example and should not impose any limitation on the functions and scope of use of the embodiments of the present disclosure.

As shown in FIG. 8, the electronic device 800 may include a processing device (for example, a central processing unit, a graphics processor, etc.) 801, which may execute various appropriate actions and processing according to a program stored in a read-only memory (ROM) 802 or a program loaded into a random access memory (RAM) 803 from a storage device 808 to implement the method of object presentation according to the embodiments of the present disclosure. In the RAM 803, various programs and data required by the operation of the terminal device 800 are also stored. The processing device 801, the ROM 802, and the RAM 803 are connected to each other through a bus 804. Input/output (I/O) interface 805 is also connected to bus 804.

Generally, the following devices may be connected to the I/O interface 805: an input device 806 including, for example, a touch screen, a touchpad, a keyboard, a mouse, a camera, a microphone, an accelerometer, a gyroscope, etc. ; an output device 807 including, for example, a liquid crystal display (LCD), a speaker, a vibrator, etc. ; a storage device 808 including, for example, a magnetic tape, a hard disk, etc. ; and a communication device 809. The communication device 809 may allow the terminal device 800 to communicate wirelessly or wired with other devices to exchange data. Although FIG. 8 illustrates a terminal device 800 having various devices, it should be understood that all illustrated devices are not required to be implemented or provided. More or fewer devices may alternatively be implemented or provided.

In particular, according to an embodiment of the present disclosure, the process described above with reference to the flowchart may be implemented as a computer software program. For example, embodiments of the present disclosure include a computer program product including a computer program carried on a non-transitory computer readable medium, the computer program containing program code for performing the method shown in the flowchart to implement the method of object presentation as described above. In such embodiments, the computer program may be downloaded and installed from the network through the communication device 809, or installed from the storage device 808, or from the ROM 802. When the computer program is executed by the processing device 801, the foregoing functions defined in the method of the embodiments of the present disclosure are performed.

It should be noted that the computer-readable medium described above of the present disclosure may be a computer readable signal medium, a computer readable storage medium, or any combination of the foregoing two. The computer-readable storage medium may be, for example, but not limited to, an electrical, magnetic, optical, electromagnetic, infrared, or semiconductor system, apparatus, or device, or any combination thereof. More specific examples of computer-readable storage media may include, but are not limited to, an electrical connection having one or more wires, a portable computer diskette, a hard disk, a random access memory (RAM), a read-only memory (ROM), an erasable programmable read-only memory (EPROM or Flash memory), an optical fiber, a portable compact disk read-only memory (CD-ROM), an optical storage device, a magnetic storage device, or any suitable combination of the foregoing. In the present disclosure, a computer-readable storage medium may be any tangible medium containing or storing a program that may be used by or in connection with an instruction execution system, apparatus, or device. In the present disclosure, a computer readable signal medium may include a data signal propagated in baseband or as part of a carrier, where the computer readable program code is carried. Such propagated data signals may take a variety of forms including, but not limited to, electromagnetic signals, optical signals, or any suitable combination of the foregoing. The computer readable signal medium may also be any computer readable medium other than a computer readable storage medium that may send, propagate, or transmit a program for use by or in connection with an instruction execution system, apparatus, or device. The program code embodied on the computer-readable medium may be transmitted with any suitable medium, including, but not limited to: wires, optical cables, RF (radio frequency), and the like, or any suitable combination of the foregoing.

In some implementations, the client, server may communicate using any currently known or future developed network protocol, such as HTTP (HyperText Transfer Protocol), and may be interconnected with any form or medium of digital data communication (e.g., a communication network). Examples of communication networks include local area networks (“LANs”), wide area networks (“WANs”), internets (e.g., the Internet), and peer-to-peer networks (e.g., ad hoc peer-to-peer networks), as well as any currently known or future developed networks.

The computer-readable medium described above may be included in the electronic device; or may be separately present without being assembled into the electronic device.

The computer readable medium carries one or more programs, and when the one or more programs are executed by the terminal device, the terminal device is caused to: in response to receiving a trigger operation by a user, displaying a recommended resource presentation page, wherein the recommended resource presentation page comprises a target candidate resource presentation area configured to present resource prompt information corresponding to a target object; in response to receiving a trigger operation for the target candidate resource presentation area, displaying an object presentation page corresponding to the target candidate resource presentation area, wherein the object presentation page is configured for the target object, resource attribute information corresponding to the target object, an associated object associated with the target object, and resource attribute information corresponding to respective associated objects.

In a possible implementation of the present disclosure, when the one or more programs are executed by the terminal device, the terminal device may further perform other steps described in the foregoing embodiments.

Computer program code for performing the operations of the present disclosure may be written in one or more programming languages, including, but not limited to, object-oriented programming languages such as Java, Smalltalk, C++, and conventional procedural programming languages, such as the “C” language or similar programming languages. The program code may execute entirely on a user computer, partially on a user computer, as a stand-alone software package, partially on a user computer and partially on a remote computer, or entirely on a remote computer or server. In the case of a remote computer, the remote computer may be connected to the user computer through any kind of network, including a local area network (LAN) or a wide area network (WAN), or may be connected to an external computer (e.g., connected through the Internet using an Internet service provider).

The flowcharts and block diagrams in the figures illustrate architecture, functionality, and operation of possible implementations of systems, methods, and computer program products according to various embodiments of the present disclosure. In this regard, each block in the flowchart or block diagram may represent a module, program segment, or portion of code that includes one or more executable instructions for implementing the specified logical function. It should also be noted that in some alternative implementations, the functions noted in the blocks may also occur in a different order than that illustrated in the figures. For example, two consecutively represented blocks may actually be performed substantially in parallel, which may sometimes be performed in the reverse order, depending on the functionality involved. It is also noted that each block in the block diagrams and/or flowcharts, as well as combinations of blocks in the block diagrams and/or flowcharts, may be implemented with a dedicated hardware-based system that performs the specified functions or operations, or may be implemented in a combination of dedicated hardware and computer instructions.

The units involved in the embodiments of the present disclosure may be implemented in software or may be implemented in hardware. The name of the unit does not constitute a limitation on the unit itself in some cases.

The functions described above herein may be performed, at least in part, by one or more hardware logic components. For example, without limitation, example types of hardware logic components that may be used include: field programmable gate arrays (FPGAs), application specific integrated circuits (ASICs), application specific standard products (ASSPs), system-on-a-chip (SOCs), complex programmable logic devices (CPLDs), and the like.

In the context of the present disclosure, a machine-readable medium may be a tangible medium that may contain or store a program for use by or in connection with an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, devices, or devices, or any suitable combination of the foregoing. More specific examples of machine-readable storage media may include electrical connections based on one or more lines, portable computer disks, hard disks, random access memory (RAM), read-only memory (ROM), erasable programmable read-only memory (EPROM or Flash memory), optical fibers, portable compact disc read-only memory (CD-ROM), optical storage devices, magnetic storage devices, or any suitable combination of the foregoing.

According to one or more embodiments of the present disclosure, the present disclosure provides a method of object presentation, including: in response to receiving a trigger operation by a user, displaying a recommended resource presentation page, wherein the recommended resource presentation page comprises a target candidate resource presentation area configured to present resource prompt information corresponding to a target object; and in response to receiving a trigger operation for the target candidate resource presentation area, displaying an object presentation page corresponding to the target candidate resource presentation area, where the object presentation page is configured for the target object, resource attribute information corresponding to the target object, an associated object associated with the target object, and resource attribute information corresponding to respective associated object.

According to one or more embodiments of the present disclosure, the present disclosure provides a method of object presentation, including: the target object is an object determined based on a predetermined object comprising one or more of: a browsed object recommended in a live streaming room, a browsed object recommended in a video information flow, an object corresponding to browsed object attribute detail information, or an object for which a predetermined interactive operation has been performed

According to one or more embodiments of the present disclosure, the present disclosure provides a method of object presentation, wherein in accordance with a determination that the target object is one of at least one object and the at least one target object is of a same object category, a plurality of target objects of the same object category is presented in the target candidate resource presentation area and the resource attribute information of the plurality of target objects satisfies a first predetermined condition, wherein the first predetermined condition comprises that after respective resource attribute information of the target object and the associated object of the object category are sorted based on a set rule, a first predetermined number of resource attribute information sorted in the front.

According to one or more embodiments of the present disclosure, the present disclosure provides a method of object presentation, wherein in accordance with a determination that the target object is one of a plurality of target objects and the plurality of target objects is of a plurality of object categories, only one target object in each object category is presented in the target candidate resource presentation area, wherein the resource attribute information of the target object presented in the each object category satisfies a second predetermined condition, and the second predetermined condition comprises that for each object category, the presented target object corresponding to the object category is an object with smallest resource attribute information in the object category, or the presented target object corresponding to the object category is an object with largest resource attribute information in the object category; the presenting order of the target objects corresponding to the plurality of object categories respectively is determined based on historical browsing times corresponding to respective object categories respectively.

According to one or more embodiments of the present disclosure, the present disclosure provides a method of object presentation, wherein the target candidate resource presentation area comprises a first area and at least one second area, each second area presents resource attribute information corresponding to one target object, and the target object presented in each second area is different; and the first area is an area other than the second area in the target candidate resource presentation area; in response to receiving the trigger operation for the target candidate resource presentation area, displaying the object presentation page corresponding to the target candidate resource presentation area includes: in response to receiving a trigger operation for any second area, displaying, in the object presentation page, resource attribute information corresponding to a target object corresponding to the triggered second area and resource attribute information corresponding to an associated object related to the target object; in response to receiving a trigger operation for the first area, displaying, in the object presentation page, resource attribute information corresponding to a target object comprised in all object categories, and resource attribute information corresponding to an associated object comprised in all object categories related to the target object.

According to one or more embodiments of the present disclosure, the present disclosure provides a method of object presentation, wherein the presenting order of the target object or the associated object comprised in each object category presented in the object presentation page is determined by a sorting order of the resource attribute information corresponding to the target object or the associated object; and in accordance with a determination that the resource attribute information of at least two objects is the same, the presenting order of the at least two objects is determined by the association relationship between the user and a user associated with the object, and the at least two objects comprise the target object and/or the associated object.

According to one or more embodiments of the present disclosure, the present disclosure provides a method of object presentation, further comprising: in response to a trigger operation for any target object or associated object in the object presentation page, displaying a page associated with object, wherein the page associated with the object comprises a combination of one or more of: an object detail page, configured to present attribute detail information of a triggered target object or an associated object, wherein the attribute detail information comprises at least one or more of an object title, resource attribute information of an object, and an object picture; a target live streaming room page, wherein the target live streaming room page is a presentation page of a live streaming room associated with the triggered target object or the associated object; a target multimedia page, wherein the target multimedia is a multimedia content presentation page associated with the triggered target object or the associated object.

According to one or more embodiments of the present disclosure, the present disclosure provides an apparatus for object presentation, including: a recommended resource presenting module, configured to in response to receiving a trigger operation by a user, display a recommended resource presentation page, wherein the recommended resource presentation page comprises a target candidate resource presentation area, and the target candidate resource presentation area is configured to present resource prompt information corresponding to the target object; and an object presenting module, configured to in response to receiving a trigger operation for the target candidate resource presentation area, display an object presentation page corresponding to the target candidate resource presentation area, wherein the object presentation page is configured for a target object, resource attribute information corresponding to the target object, an associated object associated with the target object, and resource attribute information corresponding to respective associated objects.

According to one or more embodiments of the present disclosure, the present disclosure provides an apparatus for object presentation, the target object is an object determined based on a predetermined object comprising one or more of: a browsed object recommended in a live streaming room, a browsed object recommended in a video information flow, an object corresponding to browsed object attribute detail information, or an object for which a predetermined interactive operation has been performed.

According to one or more embodiments of the present disclosure, the present disclosure provides an apparatus for object presentation, in accordance with a determination that the target object is one of at least one object and the at least one target object is of a same object category, a plurality of target objects of the same object category is presented in the target candidate resource presentation area and the resource attribute information of the plurality of target objects satisfies a first predetermined condition, wherein the first predetermined condition comprises that after respective resource attribute information of the target object and the associated object of the object category are sorted based on a set rule, a first predetermined number of resource attribute information sorted in the front.

According to one or more embodiments of the present disclosure, the present disclosure provides an apparatus for object presentation, in accordance with a determination that the target object is one of a plurality of target objects and the plurality of target objects is of a plurality of object categories, only one target object in each object category is presented in the target candidate resource presentation area, wherein the resource attribute information of the target object presented in the each object category satisfies a second predetermined condition, and the second predetermined condition comprises that for each object category, the presented target object corresponding to the object category is an object with smallest resource attribute information in the object category, or the presented target object corresponding to the object category is an object with largest resource attribute information in the object category; the presenting order of the target objects corresponding to the plurality of object categories respectively is determined based on historical browsing times corresponding to respective object categories respectively.

According to one or more embodiments of the present disclosure, the present disclosure provides an apparatus for object presentation, the target candidate resource presentation area comprises a first area and at least one second area, each second area presents resource attribute information corresponding to one target object, and the target object presented in each second area is different; and the first area is an area other than the second area in the target candidate resource presentation area; the object presenting module 72 is specifically configured to in response to receiving a trigger operation for any second area, displaying, in the object presentation page, resource attribute information corresponding to a target object corresponding to the triggered second area and resource attribute information corresponding to an associated object related to the target object; and in response to receiving a trigger operation for the first area, displaying, in the object presentation page, resource attribute information corresponding to a target object comprised in all object categories, and resource attribute information corresponding to an associated object comprised in all object categories related to the target object.

According to one or more embodiments of the present disclosure, the present disclosure provides an apparatus for object presentation, the presenting order of the target object or the associated object comprised in each object category presented in the object presentation page is determined by a sorting order of the resource attribute information corresponding to the target object or the associated object; and in accordance with a determination that the resource attribute information of at least two objects is the same, the presenting order of the at least two objects is determined by the association relationship between the user and a user associated with the object, and the at least two objects comprise the target object and/or the associated object.

According to one or more embodiments of the present disclosure, the present disclosure provides an apparatus for object presentation, and the apparatus further includes: an object association page presenting module, configured to in response to a trigger operation for any target object or associated object in the object presentation page, displaying a page associated with object, wherein the page associated with the object comprises a combination of one or more of: an object detail page, configured to present attribute detail information of a triggered target object or an associated object, wherein the attribute detail information comprises at least one or more of an object title, resource attribute information of an object, and an object picture; a target live streaming room page, wherein the target live streaming room page is a presentation page of a live streaming room associated with the triggered target object or the associated object; a target multimedia page, wherein the target multimedia is a multimedia content presentation page associated with the triggered target object or the associated object.

According to one or more embodiments of the present disclosure, an embodiment of the present disclosure provides an electronic device, including: one or more processors; a storage device, configured to store one or more programs; when the one or more programs are executed by the one or more processors, the one or more processors implement the method of object presentation according to any of the first aspect.

According to one or more embodiments of the present disclosure, an embodiment of the present disclosure provides a computer-readable storage medium having a computer program stored thereon, the program, when executed by a processor, implements the method of object presentation according to any of the first aspect.

According to one or more embodiments of the present disclosure, an embodiment of the present disclosure provides a computer program product, where the computer program product includes a computer program or an instruction, and the computer program or the instruction when executed by a processor, implement the method of object presentation according to any of the first aspect.

The above description is merely an illustration of the preferred embodiments of the present disclosure and the principles of the application. It should be understood by those skilled in the art that the disclosure scope in the present disclosure is not limited to the technical solutions of the specific combination of the above technical features and should also cover other technical solutions formed by any combination of the above technical features or their equivalent features without departing from the above disclosed concept. For example, the above features and the technical features disclosed in the present disclosure (but not limited to) having similar functions are replaced with each other to form the technical solution.

Further, while operations are depicted in a particular order, this should not be done to require those operations to be performed in the particular order shown or in sequential order. In certain circumstances, multitasking and parallel processing may be advantageous. Likewise, while several specific implementation details are included in the discussion above, these should not be construed as limiting the scope of the present disclosure. Certain features described in the context of separate embodiments may also be implemented in combination in a single embodiment. Conversely, the various features described in the context of a single embodiment may also be implemented in multiple embodiments either individually or in any suitable sub-combination.

Although the present subject matter has been described in language specific to structural features and/or methodological acts, it is to be understood that the subject matter defined in the appended claims is not necessarily limited to the specific features or acts described above. Rather, the specific features and acts described above are merely example forms of implementing the claims.

1. A method of object presentation, comprising:
in response to receiving a trigger operation by a user, displaying a recommended resource presentation page, wherein the recommended resource presentation page comprises a target candidate resource presentation area configured to present resource prompt information corresponding to a target object;
in response to receiving a trigger operation for the target candidate resource presentation area, displaying an object presentation page corresponding to the target candidate resource presentation area, wherein the object presentation page is configured to present the target object, resource attribute information corresponding to the target object, an associated object associated with the target object, and resource attribute information corresponding to respective associated objects.

2. The method according to claim 1, wherein the target object is an object determined based on a predetermined object comprising one or more of: a browsed object recommended in a live streaming room, a browsed object recommended in a video information flow, an object corresponding to browsed object attribute detail information, or an object for which a predetermined interactive operation has been performed.

3. The method according to claim 1, wherein in accordance with a determination that the target object is one of at least one object and the at least one target object is of a same object category, a plurality of target objects of the same object category is presented in the target candidate resource presentation area and the resource attribute information of the plurality of target objects satisfies a first predetermined condition, wherein the first predetermined condition comprises that after respective resource attribute information of the target object and the associated object of the object category are sorted based on a set rule, a first predetermined number of resource attribute information sorted in the front.

4. The method according to claim 1, wherein in accordance with a determination that the target object is one of a plurality of target objects and the plurality of target objects is of a plurality of object categories, only one target object in each object category is presented in the target candidate resource presentation area, wherein the resource attribute information of the target object presented in the each object category satisfies a second predetermined condition, and the second predetermined condition comprises that for each object category, the presented target object corresponding to the object category is an object with smallest resource attribute information in the object category, or the presented target object corresponding to the object category is an object with largest resource attribute information in the object category; the presenting order of the target objects corresponding to the plurality of object categories respectively is determined based on historical browsing times corresponding to respective object categories respectively.

5. The method of claim 4, further comprising:
in accordance with a determination that the plurality of target objects is of a same object category, labeling a target object with smallest resource attribute information with a set identifier, wherein the set identifier is configured to indicate that the target object is the object with smallest resource attribute information, or
in accordance with a determination that the plurality of targets objects belong to the same object category, labeling the target object with largest resource attribute information with a set identifier.

6. The method according to claim 1, wherein the target candidate resource presentation area comprises a first area and at least one second area, each second area presents resource attribute information corresponding to one target object, and the target object presented in each second area is different; and the first area is an area other than the second area in the target candidate resource presentation area.

7. The method according to claim 6, wherein in response to receiving the trigger operation for the target candidate resource presentation area, displaying the object presentation page corresponding to the target candidate resource presentation area comprises:
in response to receiving a trigger operation for a second area, displaying, in the object presentation page, resource attribute information corresponding to a target object corresponding to the triggered second area and resource attribute information corresponding to an associated object related to the target object.

8. The method according to claim 6, wherein in response to receiving the trigger operation for the target candidate resource presentation area, displaying the object presentation page corresponding to the target candidate resource presentation area comprises:
in response to receiving a trigger operation for the first area, displaying, in the object presentation page, resource attribute information corresponding to a target object comprised in all object categories, and resource attribute information corresponding to an associated object comprised in all object categories related to the target object.

9. The method according to claim 6, wherein the presenting order of the target object or the associated object comprised in each object category presented in the object presentation page is determined by a sorting order of the resource attribute information corresponding to the target object or the associated object; and in accordance with a determination that the resource attribute information of at least two objects is the same, the presenting order of the at least two objects is determined by the association relationship between the user and a user associated with the object, and the at least two objects comprise the target object and/or the associated object.

10. The method according to claim 1, further comprising:
in response to a trigger operation for any target object or associated object in the object presentation page, displaying a page associated with object, wherein the page associated with the object comprises a combination of one or more of:
an object detail page, configured to present attribute detail information of a triggered target object or an associated object, wherein the attribute detail information comprises at least one or more of an object title, resource attribute information of an object, and an object picture;
a target live streaming room page, wherein the target live streaming room page is a presentation page of a live streaming room associated with the triggered target object or the associated object;
a target multimedia page, wherein the target multimedia page is a multimedia content presentation page associated with the triggered target object or the associated object.

11. The method according to claim 1, wherein the object presentation page comprises a plurality of presentation areas, each of the object presentation areas is configured to present a plurality of objects of a same category and resource attribute information corresponding to respective objects, the plurality of objects comprise the target object and the associated object associated with the target object, the object presentation area comprises an object unfold control, and the method further comprises:
presenting, in the object presentation area of the plurality of object presentation areas, resource attribute information corresponding to a first predetermined number of target objects and resource attribute information corresponding to the first predetermined number of associated objects; and
in response to a trigger operation for the object unfold control, obtaining and presenting, in the object presentation area, resource attribute information corresponding to a second predetermined number of target objects and resource attribute information corresponding to the second predetermined number of associated object, wherein the first predetermined number is less than the second predetermined number.

12. (canceled)

13. An electronic device, comprising:
one or more processors;
a storage device, configured to store one or more programs;
the one or more programs, when executed by the one or more processors, causing the one or more processors to implement acts comprising:
in response to receiving a trigger operation by a user, displaying a recommended resource presentation page, wherein the recommended resource presentation page comprises a target candidate resource presentation area configured to present resource prompt information corresponding to a target object;
in response to receiving a trigger operation for the target candidate resource presentation area, displaying an object presentation page corresponding to the target candidate resource presentation area, wherein the object presentation page is configured to present the target object, resource attribute information corresponding to the target object, an associated object associated with the target object, and resource attribute information corresponding to respective associated objects.

14. A non-transitory computer-readable storage medium having stored thereon a computer program, wherein the program, when executed by a processor, implements acts comprising:
in response to receiving a trigger operation by a user, displaying a recommended resource presentation page, wherein the recommended resource presentation page comprises a target candidate resource presentation area configured to present resource prompt information corresponding to a target object;
in response to receiving a trigger operation for the target candidate resource presentation area, displaying an object presentation page corresponding to the target candidate resource presentation area, wherein the object presentation page is configured to present the target object, resource attribute information corresponding to the target object, an associated object associated with the target object, and resource attribute information corresponding to respective associated objects.

15. (canceled)

16. The electronic device according to claim 13, wherein the target object is an object determined based on a predetermined object comprising one or more of: a browsed object recommended in a live streaming room, a browsed object recommended in a video information flow, an object corresponding to browsed object attribute detail information, or an object for which a predetermined interactive operation has been performed.

17. The electronic device according to claim 13, wherein in accordance with a determination that the target object is one of at least one object and the at least one target object is of a same object category, a plurality of target objects of the same object category is presented in the target candidate resource presentation area and the resource attribute information of the plurality of target objects satisfies a first predetermined condition, wherein the first predetermined condition comprises that after respective resource attribute information of the target object and the associated object of the object category are sorted based on a set rule, a first predetermined number of resource attribute information sorted in the front.

18. The electronic device according to claim 13, wherein in accordance with a determination that the target object is one of a plurality of target objects and the plurality of target objects is of a plurality of object categories, only one target object in each object category is presented in the target candidate resource presentation area, wherein the resource attribute information of the target object presented in the each object category satisfies a second predetermined condition, and the second predetermined condition comprises that for each object category, the presented target object corresponding to the object category is an object with smallest resource attribute information in the object category, or the presented target object corresponding to the object category is an object with largest resource attribute information in the object category; the presenting order of the target objects corresponding to the plurality of object categories respectively is determined based on historical browsing times corresponding to respective object categories respectively.

19. The electronic device according to claim 18, wherein the acts further comprise:
in accordance with a determination that the plurality of target objects is of a same object category, labeling a target object with smallest resource attribute information with a set identifier, wherein the set identifier is configured to indicate that the target object is the object with smallest resource attribute information, or
in accordance with a determination that the plurality of target objects belong to the same object category, labeling the target object with largest resource attribute information with a set identifier.

20. The electronic device according to claim 13, wherein the target candidate resource presentation area comprises a first area and at least one second area, each second area presents resource attribute information corresponding to one target object, and the target object presented in each second area is different; and the first area is an area other than the second area in the target candidate resource presentation area.

21. The electronic device according to claim 20, wherein in response to receiving the trigger operation for the target candidate resource presentation area, displaying the object presentation page corresponding to the target candidate resource presentation area comprises:
in response to receiving a trigger operation for a second area, displaying, in the object presentation page, resource attribute information corresponding to a target object corresponding to the triggered second area and resource attribute information corresponding to an associated object related to the target object.

22. The electronic device according to claim 20, wherein the presenting order of the target object or the associated object comprised in each object category presented in the object presentation page is determined by a sorting order of the resource attribute information corresponding to the target object or the associated object; and in accordance with a determination that the resource attribute information of at least two objects is the same, the presenting order of the at least two objects is determined by the association relationship between the user and a user associated with the object, and the at least two objects comprise the target object and/or the associated object.
